(19) United States
(12) Patent Application Publication
(10) Pub. No.: US 2011/0007494 A1
(43) Pub. Date: Jan. 13, 2011

(54) Optical Member And Backlight Device Using The Same

(76) Inventor: Masashi Takai, Saitama (JP)

Correspondence Address: KENEALY VAIDYA LLP, 515 EAST BRADDOCK RD SUITE B, Alexandria, VA, 22314, US

(21) Appl. No.: 12/865,394

(22) PCT Filed: Mar. 4, 2009
(86) PCT No.: PCT/JP2009/054079

§ 371 Date: Jul. 29, 2010

(30) Foreign Application Priority Data
Mar. 18, 2008 (JP) 2008-069199

(51) Int. Cl. G09F 13/08; F21V 5/00; F21V 5/02

(52) U.S. Cl. 362/97.1; 362/326; 362/339

(57) ABSTRACT

There are provided an optical member which does not degrade image quality even if it undergoes changes of temperature and humidity with time inside a liquid crystal display etc. and a backlight device using the same.

The optical member 1 of the present invention is constituted by forming a functional resin layer formed from a composition containing a resin having a glass transition temperature of 45° C. or higher on a base material, and curving the optical member 1 to protrude on the base material side. The backlight device 10 of the present invention is constituted by incorporating such an optical member 1. Preferably, curved surface of the optical member 1 is constituted to have a curvature radius in the range of 1.5 to 9.0 m.

### TECHNICAL FIELD

The present invention relates to an optical member to be used for backlight devices etc. of liquid crystal displays, electric illumination signboards, and so forth, which optical member does not degrade image quality even if it undergoes changes of temperature and humidity with time inside the liquid crystal displays etc. The present invention also relates to a backlight device utilizing such an optical member.

### BACKGROUND ART

Consumption of backlight devices used for liquid crystal displays, electric illumination signboards, and so forth is markedly increasing with increase of shipment of liquid crystal displays for notebook computers, large-sized liquid crystal televisions and so forth.

As such backlight devices, backlight devices of the edge light type and direct type are mainly used. Since backlight devices of the edge light type themselves can be made to be thin, they are used for notebook computers etc., whereas backlight devices of the direct type are usually used for large-sized liquid crystal televisions etc.

These backlight devices of the edge light type and direct type are constituted by, besides light source, light guide panel and light-diffusing panel, optical members such as prism sheet, light-diffusing film, light-reflecting film, polarization film, phase difference film and electromagnetic wave-shielding film (refer to Patent document 1).

Patent document 1: Japanese Patent Unexamined Publication (KOKAI) No. 9-127314 (claim 1, paragraph 0034)

### DISCLOSURE OF THE INVENTION

### Problem to be Solved by the Invention

Liquid crystal displays utilizing such backlight devices as described above hardly suffer from defective images over time except for those due to lighting failure of light source. However, in recent years, as the sizes of liquid crystal displays are getting larger, a phenomenon that portions showing image conditions different from those of circumferential portions are locally generated after several hours have passed from lighting of the liquid crystal displays has come to be reported.

It is considered that this phenomenon is caused by the plate-shaped members constituting the backlight devices such as light-diffusing panels and light guide panels. That is, most of light-diffusing panels and light guide panels consist of a synthetic resin from the viewpoints of optical characteristics, weight, etc., and synthetic resins generally show high water vapor permeability and tend to easily absorb moisture. If a member consisting of such a material that easily absorbs moisture is left in a highly humid environment for a long period of time, the member excessively absorbs moisture. And if a backlight device is turned on after the member has excessively absorbed moisture as described above, rapid desorption of moisture begins due to heat of the light source. This desorption of moisture does not uniformly occur in the member, and it more easily occurs near the light source. Since a portion which has desorbed moisture shrinks more compared with a portion still absorbing moisture, the member bends to protrude on the light-projecting surface side. In FIG. 1, there is shown a light-diffusing panel 2 in a state of bending to protrude on the light-projecting surface side in a conventional backlight device A.

If the light-diffusing panel 2 bends, an optical member such as prism sheet, light-diffusing film, light-reflecting film, polarization film, reflection type polarization film, phase difference film and electromagnetic wave-shielding film disposed adjacent to the light-diffusing panel or the light guide panel follows the bending shape of the light-diffusing panel 2 to bend as shown in FIG. 1. Then, there is seen a phenomenon that the bending optical member a strongly pushes a part of a member disposed on the optical member such as a liquid crystal device (not shown), and there is locally generated a portion showing image conditions different from those of circumferential portions on the display.

### Means for Solving the Problem

The inventor of the present invention conducted various researches in order to solve the aforementioned problem, then found that if a special structure of the optical member was employed, even if the light-diffusing panel or the light guide panel bent due to the change over time, the optical member adjacent to them did not strongly push a member such as a liquid crystal device present on the optical member, and therefore image quality was no longer degraded even after use for a long period of time, and accomplished the present invention.

The optical member of the present invention is an optical member comprising a base material and a functional resin layer formed on the base material, wherein the functional resin layer is formed from a composition containing a resin having a glass transition temperature of 45° C. or higher, and the optical member is curved to protrude on the base material side.

In the optical member of the present invention, curved surface preferably has a curvature radius of 1.5 to 9.0 m.

In the optical member of the present invention, the composition preferably contains the resin having a glass transition temperature of 45° C. or higher in an amount of 30% by weight or more.

In the optical member of the present invention, the functional resin layer preferably has a thickness not smaller than 5 μm and not larger than 40 μm. The present invention is preferably applied to an optical member in which the functional resin layer is formed over an area of 900 cm² or larger.

The optical member of the present invention is either one of, for example, prism sheet, light-diffusing film, light-reflecting film, polarization film, reflection type polarization film, phase difference film and electromagnetic wave-shielding film.

The backlight device of the present invention is a backlight device comprising a light source, a plate-shaped member for projecting light of the light source from a surface other than the light-entering surface, and an optical member disposed adjacent to the plate-shaped member, wherein the optical member according to any one of claims 1 to 6 is disposed as the optical member so that the functional resin layer should be on the light-projecting surface side of the backlight device.

In the backlight device of the present invention, the plate-shaped member is, for example, a light-diffusing panel disposed on one side of the light source, or a light guide panel provided with a light source disposed along at least one end of the light guide panel, of which surface approximately perpendicular to the one end serves as a light-projecting surface.

### EFFECT OF THE INVENTION

The optical member of the present invention is curved to protrude on the base material side as described above. Therefore, in a backlight device incorporated with the optical member of the present invention so that the functional resin layer should be on the light-projecting surface side, even when a light-diffusing panel or a light guide panel bends to protrude on the light-projecting surface side due to change of temperature and humidity with time, the optical member of the present invention does not follow the light-diffusing panel or the light guide panel to bend. Therefore, if the optical member of the present invention is used for a backlight device of a liquid crystal display or the like, it does not strongly push another member such as liquid crystal devices, and does not degrade image quality even after use for a long period of time.

If the light-diffusing panel or the light guide panel once bends, the original completely flat shape can hardly be restored. That is, if the light-diffusing panel or the light guide panel used together with a conventional optical member once bends, the liquid crystal display or the like permanently suffers from defective images. Therefore, the optical member of the present invention enabling elimination of the influence of the bending in such a case as described above is extremely useful.

The present invention is preferably applied especially to an optical member having a large size. An optical member having a large size (for example, an area of 900 cm² or larger) generally more easily bends compared with an optical member of a smaller size, and more easily cause defective images when it is used in a backlight device or the like. By using the optical member of the present invention, generation of defective images in a backlight device of a large area can be markedly suppressed.

### BEST MODE FOR CARRYING OUT THE INVENTION

Hereafter, embodiments of the optical member of the present invention will be explained.

The optical member of the present invention is produced by forming a functional resin layer on a base material, and is used by being disposed adjacent to a light-diffusing panel or a light guide panel of a backlight device. Specific examples of the optical member of the present invention include a prism sheet, a light-diffusing film, a light-reflecting film, a polarization film, a reflection type polarization film, a phase difference film, an electromagnetic wave-shielding film, and so forth. The light-diffusing film is used in order to improve front luminance and appropriately diffuse light, and has a small thickness as thin as 12 to 350 μm, and it is different from a light-diffusing panel used for erasing pattern of the light source.

The functional resin layer is a layer having each of the functions of the aforementioned optical members, for example, light refraction function, light-diffusing property, light-reflecting property, polarization property, and so forth, and is formed from a composition containing a resin and a material which is added as required so that the functions of the resin can be exerted. The resin contains a resin having a glass transition temperature of 45° C. or higher. If the functional resin layer is formed from a composition containing a resin having a glass transition temperature of 45° C. or higher, it becomes easy to obtain the desired curved shape according to the present invention. The glass transition temperature is particularly preferably 60° C. or higher. By using a resin having a high glass transition temperature, the predetermined curved shape can be maintained, even if a material adjacently disposed (light-diffusing panel or light guide panel) deforms. Moreover, by using a resin having a glass transition temperature of 45° C. or higher, luminance provided by the optical member at the light-projecting surface can be improved.

As such a resin, there can be used thermoplastic resins, thermosetting resins, ionizing radiation curable resins, and so forth, such as polyester resins, acrylic resins, acryl/urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins and silicone resins. Among these, acrylic resins and acryl/urethane resins showing superior light resistance and optical characteristics are preferably used.

Glass transition temperatures of these resins can be adjusted to be within a desired range by adjusting crosslinking degree or monomer composition thereof.

The resin having a glass transition temperature of 45° C. or higher is preferably contained in the composition constituting the functional resin layer in an amount of 30% by weight or more, more preferably 50% by weight or more, for more easily obtaining the desired curved shape. All the resin contained in the composition may consist of a resin having a glass transition temperature of 45° C. or higher, and in such a case, the glass transition temperature is preferably 120° C. or lower so that the optical member should not be unduly curved during the manufacture.

Since the thickness of the functional resin layer is appropriately determined so that it should exhibit a particular function among various functions, it cannot be generally defined. However, it is preferably 5 to 40 μm, more preferably 10 to 35 μm. If the functional resin layer has a thickness of 5 μm or larger, it becomes easier to obtain rigidity in such a degree that bad influences of bending of light-diffusing panel or light guide panel should be ameliorated and desired curved shape. On the other hand, if the functional resin layer has a thickness of 40 μm or smaller, excessive curving of the functional resin layer at the time of formation thereof can be prevented. Influences of curving on the optical characteristics can be thereby suppressed, and at the same time, the end of the optical member can be prevented from strongly pushing a member existing on the optical member.

The composition for forming the functional resin layer may also contain additives, for example, various organic or inorganic microparticles, photopolymerization initiators, photopolymerization enhancers, surfactants such as leveling agents and antifoams, anti-oxidants, ultraviolet absorbers, and so forth, according to the function of the layer.

When microparticles are used in the composition for forming the functional resin layer, organic microparticles are preferably used for more easily obtain optical characteristics such as favorable transparency.

As the base material, transparent plastic films formed from one or more kinds of resins selected from polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, vinyl resins, polyethylene resins, polystyrene resins, polypropylene resins, polyamide resins, polyimide resins, melamine resins, phenol resins, silicone resins, fluorocarbon resins, cyclic olefin resins, and so forth can be used. In particular, stretched, especially biaxially stretched, polyethylene terephthalate films are preferred, because of superior mechanical strength and dimensional stability thereof. Further, those of which surfaces are subjected to a corona discharge treatment and those provided with an adhesion-promoting layer are also preferably used, in order to improve adhesion to the functional resin layer.

The base material preferably has a thickness of 100 to 400 μm. The optical member of the present invention is used in a perpendicular position in many cases when it is incorporated into a backlight device etc. If the base material has a thickness of 100 μm or larger, generation of corrugation in a lower part of the member by gravity can be prevented when it is used in the aforementioned position. Further, the upper limit of the thickness is defined for the reasons that use of a base material having a thickness larger than 400 μm is not practical, and such a thickness degrades workability in the secondary elaboration.

Further, the surface of the base material of the optical member of the present invention opposite to the surface provided with the functional resin layer may be subjected to a fine matting treatment in order to prevent adhesion with other members, or a treatment for preventing reflection in order to improve light transmittance. Furthermore, a back coat layer, an antistatic layer, an adhesive layer etc. may be provided. These layers preferably have a thickness not larger than the half of the thickness of the functional resin layer for making it easy to obtain the desired curved shape.

As for the method for providing the functional resin layer, or a back coat layer, an antistatic layer, an adhesive layer, etc. as required as described above, they can be prepared by, for example, applying a coating solution obtained by dissolving a composition for forming each of the layers in a suitable solvent with a bar coater, blade coater, spin coater, roll coater, gravure coater, curtain flow coater, die coater, spray, or by screen printing, or the like, and drying it.

The shape of the optical member of the present invention is explained below. The optical member of the present invention is a member in the form of film or sheet comprising the base material and the functional resin layer provided on the base material, and has a curved shape protruding on the base material side as a whole.

Conventional optical members to be incorporated into backlight devices etc. are not supposed to have curve in order not to produce any portion unevenly contacting with an adjacent member or not to generate corrugation in an adjacent member when they are incorporated into the backlight devices etc. Unlike them, the optical member of the present invention has a curve of predetermined curvature and therefore can avoid influences of bending of a light-diffusing panel or light guide panel with minimizing uneven contact with an adjacent member and generation of corrugation.

The curved surface of the optical member preferably has a curvature radius of 1.5 to 9.0 m. If the curvature radius is 1.5 m or larger, the end of the optical member can be prevented from strongly pushing a member existing on the optical member due to excessive curving, and various functions thereof as an optical member can be prevented from being degraded by deformation. On the other hand, if the curvature radius is 9.0 m or smaller, bad influence of bending of the light-diffusing panel or light guide panel can be eliminated. The curvature radius is more preferably 3.0 to 9.0 m.

When the optical member is a rectangular optical member, for example, the member may have a curvature radius within the aforementioned range along at least the long side direction to attain the curve, and a section of the member parallel to the short side may be straight, or may curl to protrude on the base material side. In the latter case, the member must have a curvature radius of 9.0 m or smaller also for the short side direction. Whether the curvature radius of the curve is within the aforementioned rage can be confirmed by, for example, perpendicularly hanging the optical member having a rectangular shape with the end along the short side as the upper end, and determining the curvature radius of the arcing long side.

The aforementioned curl (curvature) of the optical member can be formed by using curing shrink of the functional resin layer at the time of producing the optical member. That is, if a coating solution obtained by dissolving a composition for forming the functional resin layer in a suitable solvent is applied on the base material and then dried as mentioned above, the functional resin layer causes thermal shrinkage. Therefore, the optical member is curved to protrude on the base material side, and the structure of the present invention can be obtained.

In addition, as an auxiliary method for generating the curve by curing shrinkage mentioned above, it is also possible to use a base material which is curved in advance.

Since the optical member of the present invention has the structure that it is curved to protrude on the base material side, when it is incorporated into a backlight device 10 as shown in FIG. 2, even if the light-diffusing panel and the light guide panel 2 bend to protrude on the light-projecting surface side due to change with time, the optical member 1 does not follow the bending shape, and ameliorates the bending of the light-diffusing panel or the light guide panel 2 (FIG. 2). In addition, the optical member does not strongly push the member existing on the optical member. Moreover, since the functional resin layer is formed with a composition containing a resin having a glass transition temperature of 45° C. or higher, it shows extremely little change with time. Therefore, by using such an optical member of the present invention, degradation of image quality can be prevented even after use for a long period of time.

Since the optical member of the present invention is hardly affected by deformation of an adjacent member, and shows extremely little change of shape with time, it is suitably used for backlight devices for liquid crystal displays and electric illumination signboards, and so forth.

Embodiments of the backlight device of the present invention provided with the optical member of the present invention will be explained below. The backlight device of the present invention is constituted by at least a light-diffusing panel or a light guide panel, a light source, and the optical member of the present invention. By using the optical member of the present invention in a backlight device, the optical member adjacent to the light-diffusing panel and the light guide panel does not strongly push a member existing on the optical member such as liquid crystal devices, even if the light-diffusing panel and the light guide panel bend with change of temperature or humidity to protrude on the light-projecting surface side, and degradation of image quality can be prevented even after use for a long period of time.

When the optical member of the present invention is used for a backlight device of the direct type, it is preferred that, in the backlight device comprising a light source, a light-diffusing panel disposed on one side of the light source, and an optical member disposed on the side of the light-diffusing panel opposite to the side of the light source, the optical member of the present invention is disposed so that the functional resin layer thereof should be on the light-projecting surface side. By disposing the optical member of the present invention as described above, it can ameliorate bending of the light-diffusing panel, thus it does not strongly push a member existing on the optical member such as liquid crystal devices, and degradation of image quality can be prevented even after use for a long period of time.

An embodiment of a backlight device of the direct type according to the present invention is shown in FIG. 3. As shown in the drawing, this backlight device 10 has a structure that multiple light sources 3 are disposed on an optical member (reflecting film) a held in a chassis 4, an optical member of the present invention (light-diffusing film) 1 is placed over them via a light-diffusing panel 2 so that the functional resin layer thereof should be on the light-projecting surface side, and another optical member (prism sheet) a is further placed thereon.

The light-diffusing panel is provided over the light sources of the backlight device of the direct type, and plays a role of erasing the pattern of the light sources, and it mainly consists of a synthetic resin. Since such a light-diffusing panel is used in order to support the optical member and to erase the pattern of the light sources, it must have a large thickness as thick as 1 to 10 mm, and it is different from a light-diffusing film having a thickness of 12 to 350 μm, which is used in order to improve front luminance and give an appropriate viewing angle. Moreover, although the area of the light-diffusing panel is not particularly limited, the present invention exerts especially marked effect with a light-diffusing panel having a large area of 900 cm² or larger, which relatively easily suffers from the problem of bending.

Examples of the synthetic resin constituting the light-diffusing panel include thermoplastic resins, thermosetting resins, ionizing radiation curing resins, and so forth, such as polyester resins, acrylic resins, acryl/urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins and silicone resins. Among these, acrylic resins showing superior optical characteristics are preferably used.

To the light-diffusing panel, microparticles are added in order to impart a light-diffusing property. Examples of the microparticles include inorganic microparticles such as those of silica, clay, talc, calcium carbonate, calcium sulfate, barium sulfate, aluminum silicate, titanium oxide, synthetic zeolite, alumina, and smectite, as well as organic microparticles such as those of styrene resin, urethane resin, benzoguanamine resin, silicone resin, and acrylic resin.

As the light source, cold-cathode tubes, LED light sources etc. are mainly used. Examples of the shape of the light source include a point shape, linear shape, L-shape, and so forth.

In addition, not only the optical member of the present invention, but also known optical members can be optionally used in combination for the backlight device.

When the optical member of the present invention is used for a backlight device of the edge light type, it is preferred that, in the backlight device comprising a light guide panel provided with a light source disposed along at least one end of the light guide panel, of which surface substantially perpendicular to the one end serves as a light-projecting surface, and an optical member disposed on the light-projecting surface of the light guide panel, the optical member of the present invention is disposed so that the functional resin layer thereof should be on the light-projecting surface side. By disposing the optical member of the present invention as described above, bending of the light-diffusing panel can be ameliorated, thus it does not strongly push a member existing on the optical member such as liquid crystal devices, and degradation of image quality can be prevented even after use for a long period of time.

One embodiment of the backlight device of the edge light type according to the present invention is shown in FIG. 4. This backlight device 20 has a configuration that light source 3 is provided on one side of a light guide panel 2, an optical member of the present invention (light-diffusing film) 1 is placed on the upside of the light guide panel 2 so that the functional resin layer should be on the light-projecting surface side, and an optical member (prism sheet) a is further placed thereon. The light source 3 is covered with another optical member (light-reflecting film) a except for the part facing the light guide panel 2 so that lights from the light source should efficiently enter into the light guide panel 2. Moreover, another optical member (light-reflecting film) a stored in a chassis 4 is provided under the light guide panel 2.

The light guide panel is molded to have a substantially plate-like shape at least one of which sides serves as a light-entering surface and one of which surfaces perpendicular to the side serves as a light-projecting surface. The light guide panel mainly consists of a synthetic resin. Each surface of the light guide panel may not be a uniform plane, but may have a complicated surface profile, or may be subjected to diffusion printing for a dot pattern or the like. The light guide panel has a thickness of about 1 to 10 mm. Moreover, although the area of the light guide panel is not particularly limited, the present invention exerts especially marked effect with a light guide panel having a large area of 900 cm² or larger, which is relatively easily suffers from the problem of bending.

As the resin constituting the light guide panel, those exemplified for the resin constituting the light-diffusing panel can be used, and acrylic resins showing superior optical characteristics are especially preferably used. Moreover, to the light guide panel, organic microparticles may be added, if needed. As the organic microparticles, those microparticles similar to those added to the light-diffusing panel can be used.

As the light source, those similar to those used for backlight devices of the direct type mentioned above can be used.

In addition, not only the optical member of the present invention, but also known optical members can be optionally used in combination for the backlight device.

As described above, since the optical member of the present invention, which is curved beforehand to protrude on the base material side (light-entering surface side), is incorporated into the backlight device of the present invention, even if the light-diffusing panel or the light guide panel bends to protrude on the light-projecting surface side due to change of temperature and humidity with time, the bad influence of bending can be ameliorated. Therefore, according to the present invention, there can be provided a backlight device which does not degrade image quality even after use for a long period of time.

### EXAMPLES

Hereafter, the present invention will be further explained with reference to examples. The term “part” and symbol “%” are used on weight basis, unless especially indicated.

### 1. Production of Light-Diffusing Films (Optical Members)

### Example 1

Components of a coating solution for light-diffusing layer (functional resin layer) of the following composition were mixed, and the mixture was stirred, then applied to a base material consisting of a polyethylene terephthalate film having a thickness of 188 μm (Lumirror T60, Toray Industries, Inc.) so as to obtain a dry thickness of 27 μm by the bar coating method, and dried to form an light-diffusing layer and thereby obtain a light-diffusing film (optical member) of Example 1.

### Coating Solution for Light-Diffusing Layer of Example 1

| | |
|---|---|
| Acryl polyol A | 10 parts |
| (ACRYDIC 45-116, Dainippon Ink & Chemicals, Inc., | |
| solid content: 50%, glass transition temperature: | |
| 52° C.) | |
| Isocyanate type curing agent (Takenate D110N, | 2 parts |
| Mitsui Chemicals Polyurethane, Inc., | |
| solid content: 60%) | |
| Acrylic resin particles | 10 parts |
| (Techpolymer MBX-20, Sekisui Plastics Co., Ltd., | |
| mean particle size: 20 μm) | |
| Dilution solvent | 36 parts |

### Example 2

A light-diffusing film of Example 2 was obtained in the same manner as that of Example 1, except that the coating solution for light-diffusing layer of Example 1 was changed to a coating solution for light-diffusing layer of the following composition.

### Coating Solution for Light-Diffusing Layer of Example 2

| | |
|---|---|
| Acryl polyol A | 8 parts |
| (ACRYDIC 45-116, Dainippon Ink & Chemicals, Inc., | |
| solid content: 50%, glass transition temperature: | |
| 52° C.) | |
| Acryl polyol B | 2 parts |
| (ACRYDIC 52-614, Dainippon Ink & Chemicals, Inc., | |
| solid content: 50%, glass transition temperature: | |
| 19° C.) | |
| Isocyanate type curing agent (Takenate D110N, | 2 parts |
| Mitsui Chemicals Polyurethane, Inc., | |
| solid content: 60%) | |
| Acrylic resin particles | 10 parts |
| (Techpolymer MBX-20, Sekisui Plastics Co., Ltd., | |
| mean particle size: 20 μm) | |
| Dilution solvent | 36 parts |

### Example 3

A light-diffusing film of Example 3 was obtained in the same manner as that of Example 2, except that, in the coating solution for light-diffusing layer of Example 2, the amount of the acryl polyol A was changed to 6 parts, and the amount of the acryl polyol B was changed to 4 parts.

### Example 4

A light-diffusing film of Example 4 was obtained in the same manner as that of Example 2, except that, in the coating solution for light-diffusing layer of Example 2, the amount of the acryl polyol A was changed to 4 parts, and the amount of the acryl polyol B was changed to 6 parts.

### Example 5

A light-diffusing film of Example 5 was obtained in the same manner as that of Example 2, except that, in the coating solution for light-diffusing layer of Example 2, the amount of the acryl polyol A was changed to 2 parts, and the amount of the acryl polyol B was changed to 8 parts.

### Comparative Example 1

A light-diffusing film of Comparative Example 1 was obtained in the same manner as that of Example 2, except that, in the coating solution for light-diffusing layer of Example 2, the acryl polyol A was not added, and the amount of the acryl polyol B was changed to 10 parts.

### Comparative Example 2

A light-diffusing film of Comparative Example 2 was obtained in the same manner as that of Example 1, except that the coating solution for light-diffusing layer of Example 1 was changed to a coating solution for light-diffusing layer of the following composition.

### Coating Solution for Light Diffusing Layer of Comparative Example 2

| | |
|---|---|
| Acryl polyol C | 10 parts |
| (Hitaloid 3901B, Hitachi Chemical Co., Ltd., | |
| solid content: 50%, glass transition temperature: | |
| 35° C.) | |
| Isocyanate type curing agent (Takenate D110N, | 2 parts |
| Mitsui Chemicals Polyurethane, Inc., | |
| solid content: 60%) | |
| Acrylic resin particles | 10 parts |
| (Techpolymer MBX-20, Sekisui Plastics Co., Ltd., | |
| mean particle size: 20 μm) | |
| Dilution solvent | 36 parts |

### Comparative Example 3

A light-diffusing film of Comparative Example 3, which was curved to protrude on the base material side, was obtained by placing the same base material as that of Example 1 in a container with a bottom curved to protrude toward outside, applying the coating solution for light-diffusing layer used in Comparative Example 1 on the base material by the bar coating method, and drying it to form a light-diffusing layer having a thickness of 27 μm.

The light-diffusing films obtained in Examples 1 to 5 and Comparative Examples 1 to 3 were observed, and it was found that all of the light-diffusing film of Examples 1 to 5 were curved to protrude on the base material side. Further, the light-diffusing films obtained in Examples 1 to 5 were each cut into a size of the short side of 50 cm and the long side of 85 cm, and hung, and the curvature radius of the arcing long side was measured. It was found that the curvature radii were 1.3 m, 2.2 m, 4.5 m, 8.2 m and 9.5 m, respectively. On the other hand, the light-diffusing films of Comparative Examples 1 and 2 were not curved, and they had a flat shape. The light-diffusing film of Comparative Example 3 was curved to protrude on the base material side, like the light-diffusing films of Examples 1 to 5. It was cut into a size of the short side of 50 cm and the long side of 85 cm, and hung, and the curvature radius of the arched long side was measured. It has found that the curvature radius was 3.8 m.

### 2. Production of Backlight Devices

As a backlight device, a direct type backlight device (area of light-projecting surface: 4121 cm²) was taken out from a commercially available 37-inch liquid crystal display utilizing the direct type backlight device. The direct type backlight device comprised a light-diffusing panel, a light-diffusing film, a prism sheet and a polarization film on a light source.

Then, the light-diffusing film was taken out from the direct type backlight device, and each of the light-diffusing films of Examples 1 to 5 according to the present invention and those of Comparative Examples 1 to 3 was incorporated instead to obtain backlight devices of Examples 1 to 5 and Comparative Examples 1 to 3. All the light-diffusing films of Examples 1 to 5 and Comparative Examples 1 to 3 were incorporated so that the light-diffusing layer should be on the light-projecting surface side.

### 3. Evaluation

Each of the backlight devices comprising the light-diffusing films of Examples 1 to 5 and Comparative Examples 1 to 3 was returned to the commercially available 37-inch liquid crystal display, and left in an environment of 40° C. and 90% RH for 24 hours, then the liquid crystal display was turned on, and image conditions were observed.

All of the light-diffusing panels of the backlight devices of Examples 1 to 5 bent to protrude on the light-projecting surface side during the aforementioned examination. However, since the backlight devices of Examples 1 to 5 used the light-diffusing films of the present invention, the light-diffusing films of the present invention ameliorated the bending of the light-diffusing panels, and they did not strongly push optical members such as prism sheets or liquid crystal devices present on the light-diffusing films. Therefore, image defects were not generated on the liquid crystal displays for hours since they were turned on.

Since the backlight devices of Examples 2 to 4 used the light-diffusing films of the present invention comprising more than 30% by weight of the resin having a glass transition temperature higher than 45° C. in the composition forming the light-diffusing layer and having a curvature radius in the range of 1.5 to 9 m, they similarly did not suffer from image defects on the liquid crystal displays even after the aforementioned examination was repeated again.

The light-diffusing panels of the backlight devices of Comparative Examples 1 to 3 similarly bent to protrude on the light-projecting surface side during the aforementioned examination. Since the backlight devices of Comparative Examples 1 and 2 used the light-diffusing films not comprising a resin having a glass transition temperature of 45° C. or higher in the composition forming the light-diffusing layer and not being curved to protrude on the base material side, the light-diffusing films themselves bent by following the bending shapes of the light-diffusing panels, and strongly pushed the optical members such as prism sheets or liquid crystal devices present on the light-diffusing films to locally generate image defects.

Although the backlight device of Comparative Example 3 comprised a light-diffusing film curved to protrude on the base material side, it was a light-diffusing film not comprising a resin having a glass transition temperature of 45° C. or higher in the composition forming the light-diffusing layer, therefore not only the light-diffusing panel, but also the light-diffusing film gradually deformed during the aforementioned examination. The light-diffusing film which had originally curled to protrude on the light-entering surface side began to follow the bending shape of the light-diffusing panel, and eventually bent to protrude on the light-protecting surface side. As a result, the light-diffusing film incorporated into the backlight device of Comparative Example 3 strongly pushed the optical members such as prism sheets or liquid crystal devices present on the light-diffusing film to locally generate image defects, as in Comparative Examples 1 and 2.

### BRIEF DESCRIPTION OF THE DRAWINGS

FIG. 1 shows an embodiment of conventional backlight device.

FIG. 2 shows an embodiment of the backlight device of the present invention.

FIG. 3 shows another embodiment of the backlight device of the present invention.

FIG. 4 shows yet another embodiment of the backlight device of the present invention.

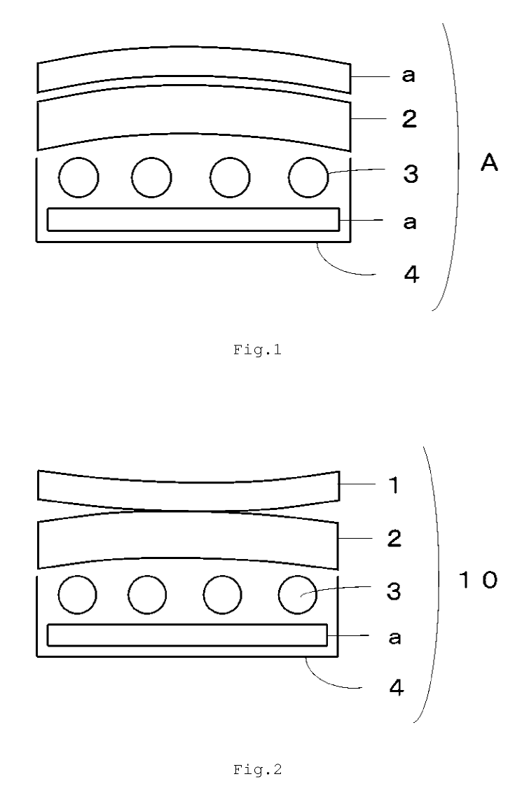

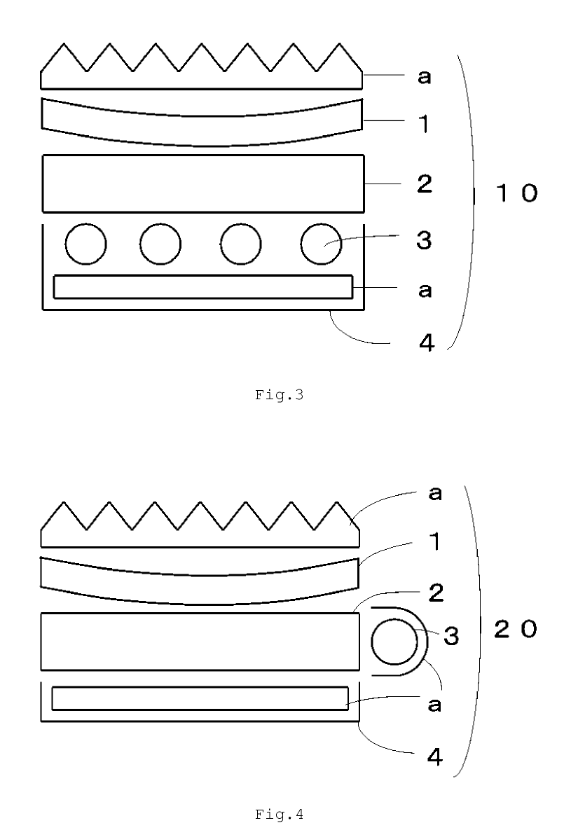

### DESCRIPTION OF NUMERICAL NOTATIONS

a . . . Conventional optical member
1 . . . Optical member of the present invention
2 . . . Light-diffusing panel or light guide plate
3 . . . Light source
4 . . . Chassis
A . . . Conventional backlight device
10 . . . Direct type backlight device of the present invention
20 . . . Edge light type backlight device of the present invention

1. An optical member, comprising:
a base material, and
a functional resin layer formed on the base material, wherein
the functional resin layer is formed from a composition containing a resin having a glass transition temperature of 45° C. or higher, and the optical member is curved to protrude on the base material side.

2. The optical member according to claim 1, wherein the curved surface of the optical member has a curvature radius of 1.5 to 9.0 m.

3. The optical member according to claim 1, wherein the composition contains the resin having a glass transition temperature of 45° C. or higher in an amount of 30% by weight or more.

4. The optical member according to claim 1, wherein the functional resin layer has a thickness not smaller than 5 μm and not larger than 40 μm.

5. The optical member according to claim 1, wherein the functional resin layer is formed over an area of 900 cm² or larger.

6. The optical member according to claim 1, which is any one of a prism sheet, a light-diffusing film, a light-reflecting film, a polarization film, a reflection type polarization film, a phase difference film and an electromagnetic wave-shielding film.

7. A backlight device, comprising:
a light source,
a plate-shaped member for projecting light of the light source from a surface other than light-entering surface, and
an optical member disposed adjacent to the plate-shaped member, wherein the optical member according to claim 1 is disposed as the optical member so that the functional resin layer should be on the light-projecting surface side of the backlight device.

8. The optical member according to claim 2, wherein the composition contains the resin having a glass transition temperature of 45° C. or higher in an amount of 30% by weight or more.

9. The optical member according to claim 2, wherein the functional resin layer has a thickness not smaller than 5 μm and not larger than 40 μm.

10. The optical member according to claim 3, wherein the functional resin layer has a thickness not smaller than 5 μm and not larger than 40 μm.

11. The optical member according to claim 2, wherein the functional resin layer is formed over an area of 900 cm² or larger.

12. The optical member according to claim 3, wherein the functional resin layer is formed over an area of 900 cm² or larger.

13. The optical member according to claim 4, wherein the functional resin layer is formed over an area of 900 cm² or larger.

14. The optical member according to claim 2, which is any one of a prism sheet, a light-diffusing film, a light-reflecting film, a polarization film, a reflection type polarization film, a phase difference film and an electromagnetic wave-shielding film.

15. The optical member according to claim 3, which is any one of a prism sheet, a light-diffusing film, a light-reflecting film, a polarization film, a reflection type polarization film, a phase difference film and an electromagnetic wave-shielding film.

16. The optical member according to claim 4, which is any one of a prism sheet, a light-diffusing film, a light-reflecting film, a polarization film, a reflection type polarization film, a phase difference film and an electromagnetic wave-shielding film.

17. The optical member according to claim 5, which is any one of a prism sheet, a light-diffusing film, a light-reflecting film, a polarization film, a reflection type polarization film, a phase difference film and an electromagnetic wave-shielding film.

18. A backlight device, comprising:
a light source,
a plate-shaped member for projecting light of the light source from a surface other than light-entering surface, and
an optical member disposed adjacent to the plate-shaped member, wherein the optical member according to claim 2 is disposed as the optical member so that the functional resin layer should be on the light-projecting surface side of the backlight device.

19. A backlight device, comprising:
a light source,
a plate-shaped member for projecting light of the light source from a surface other than light-entering surface, and
an optical member disposed adjacent to the plate-shaped member, wherein the optical member according to claim 3 is disposed as the optical member so that the functional resin layer should be on the light-projecting surface side of the backlight device.

20. A backlight device, comprising:
a light source,
a plate-shaped member for projecting light of the light source from a surface other than light-entering surface, and
an optical member disposed adjacent to the plate-shaped member, wherein the optical member according to claim 4 is disposed as the optical member so that the functional resin layer should be on the light-projecting surface side of the backlight device.
